(19) United States
(12) Patent Application Publication
(10) Pub. No.: US 2011/0134999 A1
(43) Pub. Date: Jun. 9, 2011

(54) METHOD AND APPARATUS FOR ENCODING VIDEO, AND METHOD AND APPARATUS FOR DECODING VIDEO

(75) Inventors: Woo-jin HAN, Suwon-si (KR); Min-su CHEON, Suwon-si (KR)

(73) Assignee: SAMSUNG ELECTRONICS CO., LTD., Suwon-si (KR)

(21) Appl. No.: 12/963,746

(22) Filed: Dec. 9, 2010

(30) Foreign Application Priority Data
Dec. 9, 2009 (KR) 10-2009-0121934

(51) Int. Cl. H04N 7/50

(52) U.S. Cl. 375/240.12; 375/240.18; 375/E07.211

(57) ABSTRACT

A method and apparatus for encoding a video, and a method and apparatus for decoding a video, for increasing image compression efficiency by spatially transforming, scaling and frequency-transforming residual image data. The method of encoding an image includes spatially transforming a residual block through performing wavelet transformation or downsampling on the residual block to have a size that is equal to or smaller than a maximum size of a transformation unit when the size of the residual block is larger than the maximum size of the transformation unit, and transforming the spatially transformed residual block to a frequency domain.

### CROSS-REFERENCE TO RELATED PATENT APPLICATION

This application claims priority from Korean Patent Application No. 10-2009-0121934, filed on Dec. 9, 2009, in the Korean Intellectual Property Office, the disclosure of which is incorporated herein by reference in its entirety.

### BACKGROUND

1. Field

Apparatuses and methods consistent with exemplary embodiments of the disclosure relate to encoding and decoding a video, and more specifically, for increasing image compression efficiency through spatially transforming, scaling, and frequency-transforming residual image data.

2. Description of the Related Art

In an image compression method, such as Moving Picture Experts Group (MPEG)-1, MPEG-2, MPEG-4, or H.264/MPEG-4 Advanced Video Coding (AVC), a picture is divided into macroblocks to encode an image. Each of the macroblocks is encoded in all encoding modes that can be used in inter prediction or intra prediction, and then encoded in an encoding mode that is selected according to a bitrate used to encode the macroblock and a distortion degree of a decoded macroblock based on the original macroblock.

As hardware for reproducing and storing high resolution or high quality video content is being developed and supplied, a need for a video codec for effectively encoding or decoding the high resolution or high quality video content is increasing. In a conventional video codec, a video is predicted, transformed, quantized, and encoded in units of macroblocks each having a predetermined size.

### SUMMARY

One or more aspects of the exemplary embodiments provide methods and apparatuses for encoding an image, as well as methods and apparatuses for decoding an image, for increasing image compression efficiency by changing a size of a residual block to be proper to a size of an available transformation unit through spatial transformation, and performing frequency transformation on the changed residual block.

According to an exemplary embodiment, there is provided a method of encoding a video, the method including generating a residual block that constitutes a difference between a prediction block of a current block and the current block; determining whether a size of the residual block is larger than a maximum size of an available transformation unit; spatially transforming the residual block to have a size that is equal to or smaller than the maximum size of the available transformation unit, in response to determining that the size of the residual block is larger than the maximum size of the available transformation unit; and transforming the spatially transformed residual block to a frequency domain.

According to an exemplary embodiment, there is provided an apparatus for encoding a video, the apparatus including a spatial transformer that determines whether a size of a residual block, the residual block constituting a difference between a prediction block of a current block and the current block with a maximum size of an available transformation unit, and that spatially transforms the residual block to have a size that is equal to or smaller than the maximum size of the available transformation unit, in response to determining that the size of the residual block is larger than the maximum size of the available transformation unit; and a frequency transformer that transforms the spatially transformed residual block to a frequency domain.

According to another exemplary embodiment, there is provided a method for decoding a video, the method including extracting size information of a current residual block to be decoded and information about an encoded current residual block that is spatially transformed so that a size of the current residual block is equal to or smaller than a maximum size of an available transformation unit and transformed to a frequency domain, from a bitstream; inverse-transforming the encoded residual block from a frequency domain to a spatial domain; and spatially inverse-transforming the residual block to have a size that is equal to a size of an original residual block using the extracted size information of the current residual block that is to be decoded as a restored residual block.

According to an exemplary embodiment, there is provided an apparatus for decoding a video, the apparatus including a parser that extracts size information of a current residual block to be decoded and information about an encoded current residual block that is spatially transformed so that a size of the current residual block is equal to or smaller than a maximum size of an available transformation unit and transformed to a frequency domain, from a bitstream; a frequency inverse transformer that inverse-transforms the encoded residual block from a frequency domain to a spatial domain; and a spatial inverse-transformer that restores the residual block by spatially inverse-transforming the residual block to have a size that is equal to a size of an original residual block using the extracted size information of the current residual block that is to be decoded.

According to an exemplary embodiment, there is provided a computer readable medium having recorded thereon a program that causes a computer to execute at least one of the method of encoding a video and the method of decoding a video.

### BRIEF DESCRIPTION OF THE DRAWINGS

The above and other features and advantages will become more apparent by describing in detail exemplary embodiments thereof with reference to the attached drawings in which:

FIG. 1 is a block diagram of an apparatus for encoding a video, according to an exemplary embodiment;

FIG. 2 is a block diagram of an apparatus for decoding a video, according to an exemplary embodiment;

FIG. 3 is a diagram for describing coding units, according to an exemplary embodiment;

FIG. 4 is a block diagram of an image encoder based on coding units, according to an exemplary embodiment;

FIG. 5 is a block diagram of an image decoder based on coding units, according to an exemplary embodiment;

FIG. 6 is a diagram illustrating deeper coding units, according to depths, and partitions, according to an exemplary embodiment;

FIG. 7 is a diagram for describing a relationship between a coding unit and transformation units, according to an exemplary embodiment;

FIG. 8 is a diagram describing encoding information of coding units corresponding to a coded depth, according to an exemplary embodiment;

FIG. 9 is a diagram of deeper coding units according to depths, according to an exemplary embodiment;

FIGS. 10 through 12 are diagrams describing a relationship between coding units, prediction units, and transformation units, according to an exemplary embodiment;

FIG. 13 is a diagram describing a relationship between a coding unit, a prediction unit or a partition, and a transformation unit, according to encoding mode information, according to an exemplary embodiment;

FIG. 14 is a reference diagram describing a process of spatially transforming a current residual block, according to an exemplary embodiment;

FIG. 15 is a block diagram of a spatial transformer, according to an exemplary embodiment;

FIG. 16 is a diagram for describing a method of wavelet transformation, according to an exemplary embodiment;

FIG. 17 is a block diagram of a spatial transformer, according to an exemplary embodiment;

FIG. 18 is reference describing a process of sub-sampling performed in the spatial transformer of FIG. 17, according to an exemplary embodiment;

FIG. 19 is a flowchart of an image encoding method, according to an exemplary embodiment;

FIG. 20 is a block diagram of a spatial inverse-transformer, according to an exemplary embodiment;

FIG. 21 is a block diagram of a spatial inverse-transformer, according to an exemplary embodiment; and

FIG. 22 is a flowchart of an image decoding method according to an exemplary embodiment.

### DETAILED DESCRIPTION

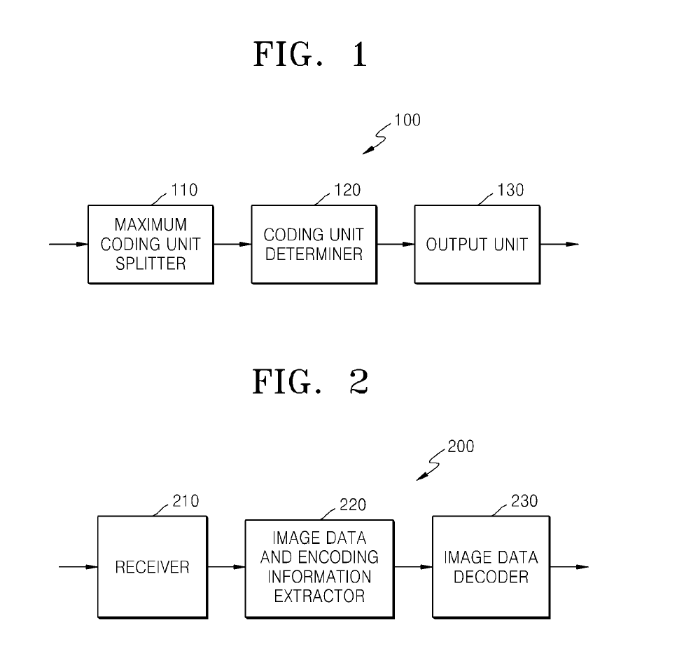

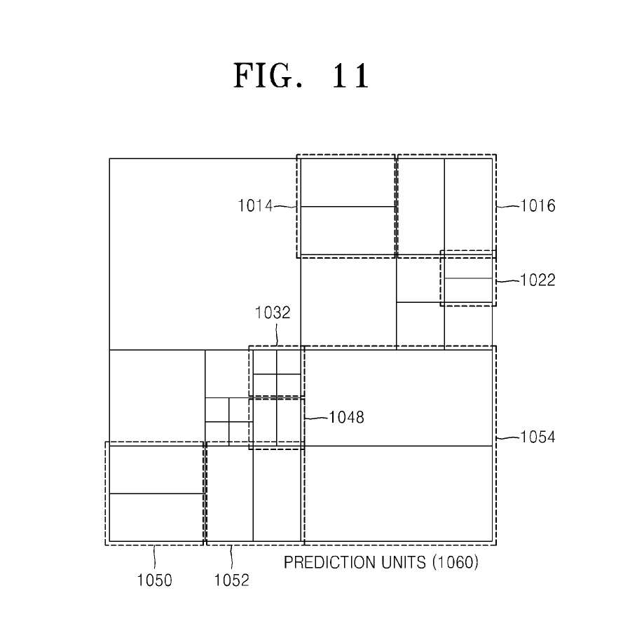

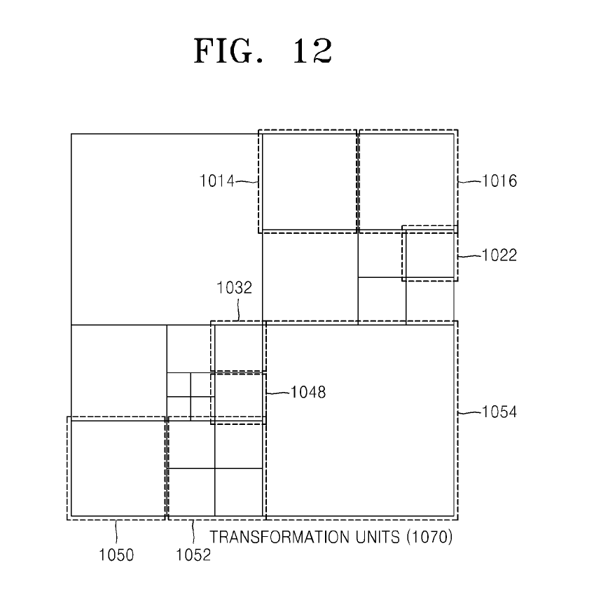

Hereinafter, apparatuses for encoding and decoding a video, and methods of encoding and decoding an image, according to exemplary embodiments will be described with reference to FIGS. 1 through 15.

Hereinafter, a ‘coding unit’ is an encoding data unit, in which image data is encoded at an encoder side, and an encoded data unit, in which the encoded image data is decoded at a decoder side, according to exemplary embodiments. Also, a ‘coded depth’ is a depth where a coding unit is encoded.

FIG. 1 is a block diagram of a video encoding apparatus 100, according to an exemplary embodiment.

The video encoding apparatus 100 includes a maximum coding unit splitter 110, a coding unit determiner 120, and an output unit 130.

The maximum coding unit splitter 110 may split a current picture based on a maximum coding unit for the current picture of an image. If the current picture is larger than the maximum coding unit, image data of the current picture may be split into the at least one maximum coding unit. The maximum coding unit according to an exemplary embodiment may be a data unit having a size of 32×32, 64×64, 128×128, 256×256, etc., and a shape of the data unit is a square having a width and length in squares of 2. The image data may be output to the coding unit determiner 120 according to the at least one maximum coding unit.

A coding unit according to an exemplary embodiment may be characterized by a maximum size and a depth. The depth denotes a number of times the coding unit is spatially split from the maximum coding unit. As the depth deepens, deeper encoding units according to depths may be split from the maximum coding unit to a minimum coding unit. A depth of the maximum coding unit is an uppermost depth, and a depth of the minimum coding unit is a lowermost depth. Since a size of a coding unit corresponding to each depth decreases as the depth of the maximum coding unit deepens, a coding unit corresponding to an upper depth may include a plurality of coding units corresponding to lower depths.

As described above, the image data of the current picture is split into the maximum coding units according to a maximum size of the coding unit, and each of the maximum coding units may include deeper coding units that are split according to depths. Since the maximum coding unit according to an exemplary embodiment is split according to depths, the image data of a spatial domain included in the maximum coding unit may be hierarchically classified according to depths.

A maximum depth and a maximum size of a coding unit, which limit the total number of times a height and a width of the maximum coding unit are hierarchically split, may be predetermined.

The coding unit determiner 120 encodes at least one split region, obtained by splitting a region of the maximum coding unit according to depths, and determines a depth to output a finally encoded image data according to the at least one split region. In other words, the coding unit determiner 120 determines a coded depth by encoding the image data in the deeper coding units according to depths, according to the maximum coding unit of the current picture, and selecting a depth having the least encoding error. Thus, the encoded image data of the coding unit corresponding to the determined coded depth is finally output. Also, the coding units corresponding to the coded depth may be regarded as encoded coding units.

The determined coded depth and the encoded image data according to the determined coded depth are output to the output unit 130.

The image data in the maximum coding unit is encoded based on the deeper coding units corresponding to at least one depth equal to or below the maximum depth, and results of encoding the image data are compared based on each of the deeper coding units. A depth having the least encoding error may be selected after comparing encoding errors of the deeper coding units. At least one coded depth may be selected for each maximum coding unit.

The size of the maximum coding unit is split as a coding unit is hierarchically split according to depths, and as the number of coding units increases. Also, even if coding units correspond to same depth in one maximum coding unit, it is determined whether to split each of the coding units corresponding to the same depth to a lower depth by measuring an encoding error of the image data of the each coding unit, separately. Accordingly, even when image data is included in one maximum coding unit, the image data is split to regions according to the depths and the encoding errors may differ according to regions in the one maximum coding unit, and thus the coded depths may differ according to regions in the image data. Thus, one or more coded depths may be determined in one maximum coding unit, and the image data of the maximum coding unit may be divided according to coding units of at least one coded depth.

Accordingly, the coding unit determiner 120 may determine coding units having a tree structure included in the maximum coding unit. The ‘coding units having a tree structure’ according to an exemplary embodiment include coding units corresponding to a depth determined to be the coded depth, from among all deeper coding units included in the maximum coding unit. A coding unit of a coded depth may be hierarchically determined according to depths in the same region of the maximum coding unit, and may be independently determined in different regions. Similarly, a coded depth in a current region may be independently determined from a coded depth in another region.

A maximum depth according to an exemplary embodiment is an index related to the number of splitting times from a maximum coding unit to a minimum coding unit. A first maximum depth according to an exemplary embodiment may denote the total number of splitting times from the maximum coding unit to the minimum coding unit. A second maximum depth according to an exemplary embodiment may denote the total number of depth levels from the maximum coding unit to the minimum coding unit. For example, when a depth of the maximum coding unit is 0, a depth of a coding unit, in which the maximum coding unit is split once, may be set to 1. Also, a depth of a coding unit, in which the maximum coding unit is split twice, may be set to 2. Here, if the minimum coding unit is a coding unit, in which the maximum coding unit is split four times, 5 depth levels of depths 0, 1, 2, 3 and 4 exist. Thus, the first maximum depth may be set to 4, and the second maximum depth may be set to 5.

Prediction encoding and transformation may be performed according to the maximum coding unit. The prediction encoding and the transformation are also performed based on the deeper coding units according to a depth equal to or depths less than the maximum depth, according to the maximum coding unit. Transformation may be performed according to method of orthogonal transformation or integer transformation.

Since the number of deeper coding units increases whenever the maximum coding unit is split according to depths, encoding including the prediction encoding and the transformation is performed on all of the deeper coding units generated as the depth deepens. For convenience of description, the prediction encoding and the transformation will now be described based on a coding unit of a current depth, in a maximum coding unit.

The video encoding apparatus 100 may variously select a size or shape of a data unit for encoding the image data. In order to encode the image data, operations, such as prediction encoding, transformation, and entropy encoding, are performed, and at this time, the same data unit may be used for all operations or different data units may be used for each operation.

For example, the video encoding apparatus 100 may select, not only a coding unit for encoding the image data, but also a data unit different from the coding unit to perform the prediction encoding on the image data in the coding unit.

In order to perform prediction encoding in the maximum coding unit, the prediction encoding may be performed based on a coding unit corresponding to a coded depth, i.e., based on a coding unit that is no longer split to coding units corresponding to a lower depth. Hereinafter, the coding unit that is no longer split, and becomes a basis unit for prediction encoding, is referred to as a ‘prediction unit’. A partition obtained by splitting the prediction unit may include a prediction unit or a data unit obtained by splitting at least one of a height and a width of the prediction unit.

For example, when a coding unit of 2N×2N (where N is a positive integer) is no longer split and becomes a prediction unit of 2N×2N, a size of a partition may be 2N×2N, 2N×N, N×2N, or N×N. Examples of a partition type include symmetrical partitions that are obtained by symmetrically splitting a height or width of the prediction unit, partitions obtained by asymmetrically splitting the height or width of the prediction unit, such as 1:n or n:1, partitions that are obtained by geometrically splitting the prediction unit, and partitions having arbitrary shapes.

A prediction mode of the prediction unit may be at least one of an intra mode, a inter mode, and a skip mode. For example, the intra mode or the inter mode may be performed on the partition of 2N×2N, 2N×N, N×2N, or N×N. Also, the skip mode may be performed only on the partition of 2N×2N. The encoding is independently performed on one prediction unit in a coding unit, thereby selecting a prediction mode having a least encoding error.

The video encoding apparatus 100 may also perform the transformation on the image data in a coding unit based, not only on the coding unit for encoding the image data, but also based on a data unit that is different from the coding unit.

To perform the transformation in the coding unit, the transformation may be performed based on a data unit having a size smaller than or equal to the coding unit. For example, the data unit for the transformation may include a data unit for an intra mode and a data unit for an inter mode.

A data unit used as a base of the transformation is referred to as a ‘transformation unit’. A transformation depth, which indicates the number of splitting times to reach the transformation unit by splitting the height and width of the coding unit, may also be set in the transformation unit. For example, in a current coding unit of 2N×2N, a transformation depth may be 0 when the size of a transformation unit is also 2N×2N. A transformation depth may be 1 when each of the height and width of the current coding unit is split into two equal parts, totally split into 4̂1 transformation units, and the size of the transformation unit is thus N×N. A transformation depth may be 2 when each of the height and width of the current coding unit is split into four equal parts, totally split into 4̂2 transformation units and the size of the transformation unit is thus N/2×N/2. For example, the transformation unit may be set according to a hierarchical tree structure, in which a transformation unit of an upper transformation depth is split into four transformation units of a lower transformation depth according to the hierarchical characteristics of a transformation depth.

Similar to the coding unit, the transformation unit in the coding unit may be recursively split into smaller sized regions, so that the transformation unit may be independently determined in units of regions. Thus, residual data in the coding unit may be divided according to the transformation having the tree structure according to transformation depths.

Encoding information according to coding units corresponding to a coded depth requires, not only information about the coded depth, but also about information related to prediction encoding and transformation. Accordingly, the coding unit determiner 120 not only determines a coded depth having a least encoding error, but also determines a partition type in a prediction unit, a prediction mode according to prediction units, and a size of a transformation unit for transformation.

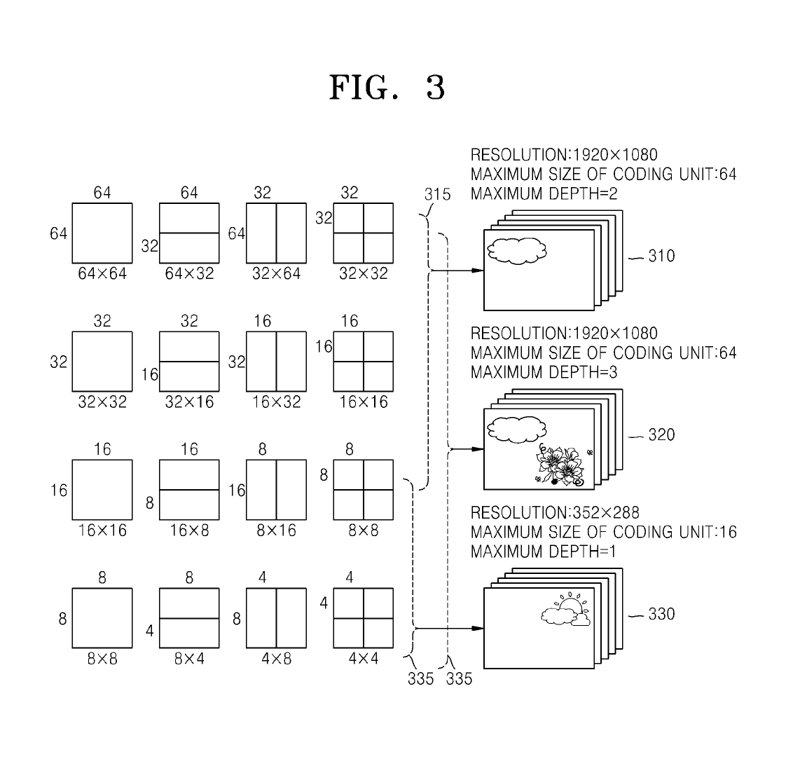

Coding units according to a tree structure in a maximum coding unit and a method of determining a partition, according to exemplary embodiments, will be described in detail later with reference to FIGS. 3 through 12.

The coding unit determiner 120 may measure an encoding error of deeper coding units according to depths by using Rate-Distortion Optimization based on Lagrangian multipliers.

The output unit 130 outputs the image data of the maximum coding unit, which is encoded based on the at least one coded depth determined by the coding unit determiner 120, and information about the encoding mode according to the coded depth, in bitstreams.

The encoded image data may be obtained by encoding residual data of an image.

The information about the encoding mode according to coded depth may include information about the coded depth, information about the partition type in the prediction unit, the prediction mode, and the size of the transformation unit.

The information about the coded depth may be defined by using split information according to depths, which indicates whether encoding is performed on coding units of a lower depth instead of a current depth. If the current depth of the current coding unit is the coded depth, image data in the current coding unit is encoded and output, and thus the split information may be defined not to split the current coding unit to a lower depth. Alternatively, if the current depth of the current coding unit is not the coded depth, the encoding is performed on the coding unit of the lower depth, and thus the split information may be defined to split the current coding unit to obtain the coding units of the lower depth.

If the current depth is not the coded depth, encoding is performed on the coding unit that is split into the coding unit of the lower depth. Since at least one coding unit of the lower depth exists in one coding unit of the current depth, the encoding is repeatedly performed on each coding unit of the lower depth, and thus the encoding may be recursively performed for the coding units having the same depth.

Since the coding units having a tree structure are determined for one maximum coding unit, and information about at least one encoding mode is determined for a coding unit of a coded depth, information about at least one encoding mode may be determined for one maximum coding unit. Also, a coded depth of the image data of the maximum coding unit may be different according to locations, since the image data is hierarchically split according to depths, and thus information about the coded depth and the encoding mode may be set for the image data.

Accordingly, the output unit 130 may assign encoding information about a corresponding coded depth and an encoding mode to at least one of the coding unit, the prediction unit, and a minimum unit included in the maximum coding unit.

The minimum unit according to an exemplary embodiment is a rectangular data unit obtained by splitting the minimum coding unit constituting the lowermost depth by 4. Alternatively, the minimum unit may be a maximum rectangular data unit that may be included in all of the coding units, prediction units, partition units, and transformation units included in the maximum coding unit.

For example, the encoding information output through the output unit 130 may be classified into encoding information according to coding units, and encoding information according to prediction units. The encoding information according to the coding units may include the information about the prediction mode and the information about the size of the partitions. The encoding information according to the prediction units may include information about an estimated direction of an inter mode, information about a reference image index of the inter mode, information about a motion vector, information about a chroma component of an intra mode, and information about an interpolation method of the intra mode. Also, information about a maximum size of the coding unit defined according to pictures, slices, or group of pictures (GOPs), and information about a maximum depth may be inserted into SPS (Sequence Parameter Set) or a header of a bitstream.

In the video encoding apparatus 100, the deeper coding unit may be a coding unit obtained by dividing a height or width of a coding unit of an upper depth, which is one layer above, by two. In other words, when the size of the coding unit of the current depth is 2N×2N, the size of the coding unit of the lower depth is N×N. Also, the coding unit of the current depth having the size of 2N×2N may include maximum 4 of the coding units of the lower depth.

Accordingly, the video encoding apparatus 100 may form the coding units having the tree structure by determining coding units having an optimum shape and an optimum size for each maximum coding unit, based on the size of the maximum coding unit and the maximum depth determined considering characteristics of the current picture. Also, since encoding may be performed on each maximum coding unit by using any one of various prediction modes and transformations, an optimum encoding mode may be determined considering characteristics of the coding unit of various image sizes.

Thus, if an image having high resolution or large data amount is encoded in a conventional macroblock, a number of macroblocks per picture excessively increases. Accordingly, a number of pieces of compressed information generated for each macroblock increases, and thus it is difficult to transmit the compressed information and data compression efficiency decreases. However, by using the video encoding apparatus 100, image compression efficiency may be increased since a coding unit is adjusted while considering characteristics of an image while increasing a maximum size of a coding unit while considering a size of the image.

FIG. 2 is a block diagram of a video decoding apparatus 200, according to an exemplary embodiment.

The video decoding apparatus 200 includes a receiver 210, an image data and encoding information extractor 220, and an image data decoder 230. Definitions of various terms, such as a coding unit, a depth, a prediction unit, a transformation unit, and information about various encoding modes, for various operations of the video decoding apparatus 200 are identical to those described with reference to FIG. 1 and the video encoding apparatus 100.

The receiver 210 receives and parses a bitstream of an encoded video. The image data and encoding information extractor 220 extracts encoded image data for each coding unit from the parsed bitstream, the coding units having a tree structure according to each maximum coding unit, and outputs the extracted image data to the image data decoder 230. The image data and encoding information extractor 220 may extract information about a maximum size of a coding unit of a current picture, from a header about the current picture or SPS.

Also, the image data and encoding information extractor 220 extracts information about a coded depth and an encoding mode for the coding units having a tree structure according to each maximum coding unit, from the parsed bitstream. The extracted information about the coded depth and the encoding mode is output to the image data decoder 230. In other words, the image data in a bit stream is split into the maximum coding unit so that the image data decoder 230 decodes the image data for each maximum coding unit.

The information about the coded depth and the encoding mode according to the maximum coding unit may be set for information about at least one coding unit corresponding to the coded depth, and information about an encoding mode may include information about a partition type of a corresponding coding unit corresponding to the coded depth, information about a prediction mode, and a size of a transformation unit. Also, splitting information according to depths may be extracted as the information about the coded depth.

The information about the coded depth and the encoding mode according to each maximum coding unit extracted by the image data and encoding information extractor 220 is information about a coded depth and an encoding mode determined to generate a minimum encoding error when an encoder, such as the video encoding apparatus 100, repeatedly performs encoding for each deeper coding unit according to depths according to each maximum coding unit. Accordingly, the video decoding apparatus 200 may restore an image by decoding the image data according to a coded depth and an encoding mode that generates the minimum encoding error.

Since encoding information about the coded depth and the encoding mode may be assigned to a predetermined data unit from among a corresponding coding unit, a prediction unit, and a minimum unit, the image data and encoding information extractor 220 may extract the information about the coded depth and the encoding mode according to the predetermined data units. The predetermined data units to which the same information about the coded depth and the encoding mode is assigned may be inferred to be the data units included in the same maximum coding unit.

The image data decoder 230 restores the current picture by decoding the image data in each maximum coding unit based on the information about the coded depth and the encoding mode according to the maximum coding units. In other words, the image data decoder 230 may decode the encoded image data based on the extracted information about the partition type, the prediction mode, and the transformation unit for each coding unit from among the coding units having the tree structure included in each maximum coding unit. A decoding process may include a prediction including intra prediction and motion compensation, and an inverse transformation. Inverse transformation may be performed according to method of inverse orthogonal transformation or inverse integer transformation.

The image data decoder 230 may perform intra prediction or motion compensation according to a partition and a prediction mode of each coding unit, based on the information about the partition type and the prediction mode of the prediction unit of the coding unit according to coded depths.

Also, the image data decoder 230 may perform inverse transformation according to each transformation unit in the coding unit, based on the information about the size of the transformation unit of the coding unit according to coded depths, so as to perform the inverse transformation according to maximum coding units.

The image data decoder 230 may determine at least one coded depth of a current maximum coding unit by using split information according to depths. If the split information indicates that image data is no longer split in the current depth, the current depth is a coded depth. Accordingly, the image data decoder 230 may decode encoded data of at least one coding unit corresponding to the each coded depth in the current maximum coding unit by using the information about the partition type of the prediction unit, the prediction mode, and the size of the transformation unit for each coding unit corresponding to the coded depth, and output the image data of the current maximum coding unit.

In other words, data units containing the encoding information including the same split information may be gathered by observing the encoding information set assigned for the predetermined data unit from among the coding unit, the prediction unit, and the minimum unit, and the gathered data units may be considered to be one data unit to be decoded by the image data decoder 230 in the same encoding mode.

The video decoding apparatus 200 may obtain information about at least one coding unit that generates the minimum encoding error when encoding is recursively performed for each maximum coding unit, and may use the information to decode the current picture. In other words, the coding units having the tree structure determined to be the optimum coding units in each maximum coding unit may be decoded. Also, the maximum size of coding unit is determined considering resolution and an amount of image data.

Accordingly, even if image data has high resolution and a large amount of data, the image data may be efficiently decoded and restored by using a size of a coding unit and an encoding mode, which are adaptively determined according to characteristics of the image data, by using information about an optimum encoding mode received from an encoder.

A method of determining coding units having a tree structure, a prediction unit, and a transformation unit, according to an exemplary embodiment, will now be described with reference to FIGS. 3 through 13.

FIG. 3 is a diagram for describing a concept of coding units according to an exemplary embodiment.

A size of a coding unit may be expressed in width×height, and may be 64×64, 32×32, 16×16, and 8×8. A coding unit of 64×64 may be split into partitions of 64×64, 64×32, 32×64, or 32×32. A coding unit of 32×32 may be split into partitions of 32×32, 32×16, 16×32, or 16×16. A coding unit of 16×16 may be split into partitions of 16×16, 16×8, 8×16, or 8×8. A coding unit of 8×8 may be split into partitions of 8×8, 8×4, 4×8, or 4×4.

In video data 310, a resolution is 1920×1080, a maximum size of a coding unit is 64, and a maximum depth is 2. In video data 320, a resolution is 1920×1080, a maximum size of a coding unit is 64, and a maximum depth is 3. In video data 330, a resolution is 352×288, a maximum size of a coding unit is 16, and a maximum depth is 1. The maximum depth shown in FIG. 3 denotes a total number of splits from a maximum coding unit to a minimum decoding unit.

If a resolution is high or a data amount is large, a maximum size of a coding unit may be large so as to, not only increase encoding efficiency, but also to accurately reflect characteristics of an image. Accordingly, the maximum size of the coding unit of the video data 310 and 320 having the higher resolution than the video data 330 may be 64.

Since the maximum depth of the video data 310 is 2, coding units 315 of the vide data 310 may include a maximum coding unit having a long axis size of 64, and coding units having long axis sizes of 32 and 16, since depths are deepened to two layers by splitting the maximum coding unit twice. Meanwhile, since the maximum depth of the video data 330 is 1, coding units 335 of the video data 330 may include a maximum coding unit having a long axis size of 16, and coding units having a long axis size of 8, since depths are deepened to one layer by splitting the maximum coding unit once.

Since the maximum depth of the video data 320 is 3, coding units 325 of the video data 320 may include a maximum coding unit having a long axis size of 64, and coding units having long axis sizes of 32, 16, and 8, since the depths are deepened to 3 layers by splitting the maximum coding unit three times. As a depth deepens, detailed information may be precisely expressed.

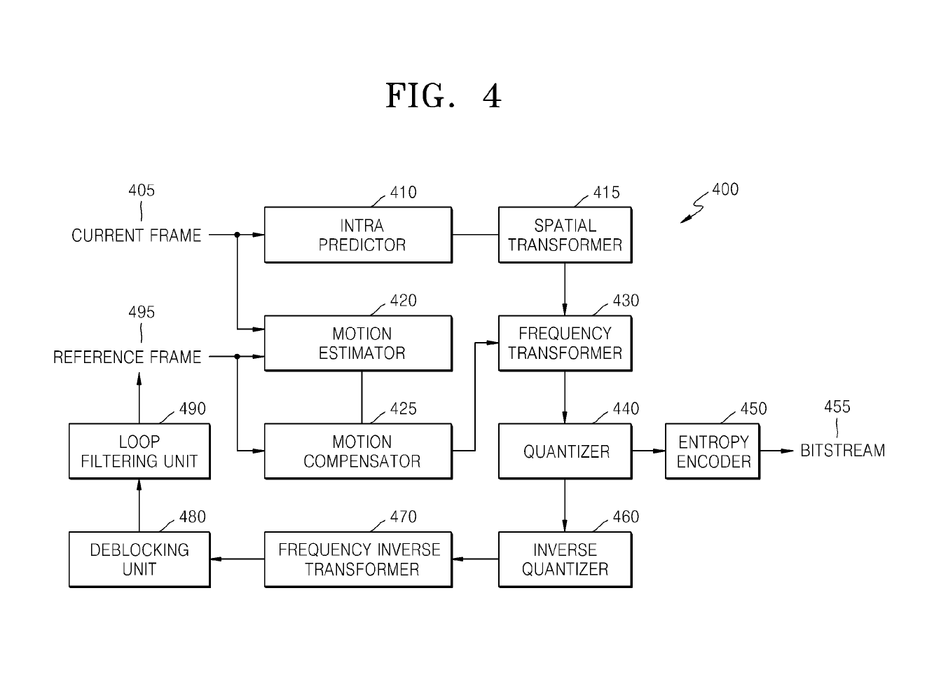

FIG. 4 is a block diagram of an image encoder 400 based on coding units, according to an exemplary embodiment.

The image encoder 400 performs operations of the coding unit determiner 120 of the video encoding apparatus 100 to encode image data. In other words, an intra predictor 410 performs intra prediction on prediction units in an intra mode, from among a current frame 405, and a motion estimator 420 and a motion compensator 425 perform inter estimation and motion compensation on prediction units in an inter mode from among the current frame 405 by using the current frame 405, and a reference frame 495.

Residual values are generated based on prediction units output from the intra predictor 410, the motion estimator 420 and the motion compensator 425, and are spatially transformed so as to have a size that is equal to or smaller than a maximum transformation unit that can be used by a spatial transformer 415. The spatially transformed residual values are output as quantized transformation coefficients through a frequency transformer 430 and a quantizer 440. A process of spatially transforming the residual values will be described in detail later.

The quantized transformation coefficient is restored as residual values through an inverse quantizer 460, and a frequency inverse transformer 470, and the restored residual values are output as the reference frame 495 after being post-processed through a deblocking unit 480 and a loop filtering unit 490. The quantized transformation coefficient is output as a bitstream 455 through an entropy encoder 450.

In order to perform encoding by using an a video encoding method according to an exemplary embodiment, all elements of the image encoder 400, i.e., the intra predictor 410, the spatial transformer 415, the motion estimator 420, the motion compensator 425, the frequency transformer 430, the quantizer 440, the entropy encoder 450, the inverse quantizer 460, the frequency inverse transformer 470, the deblocking unit 480 and the loop filtering unit 490 may perform operations based on a maximum coding unit, a sub-coding unit according to depths, a prediction unit and a transformation unit. The intra predictor 410, the motion estimator 420 and the motion compensator 425 may determine a prediction unit and a prediction mode in each coding unit while considering the maximum size and depth of each coding unit. The frequency transformer 430 may determine the size of the transformation unit while considering the maximum size and depth of each coding unit.

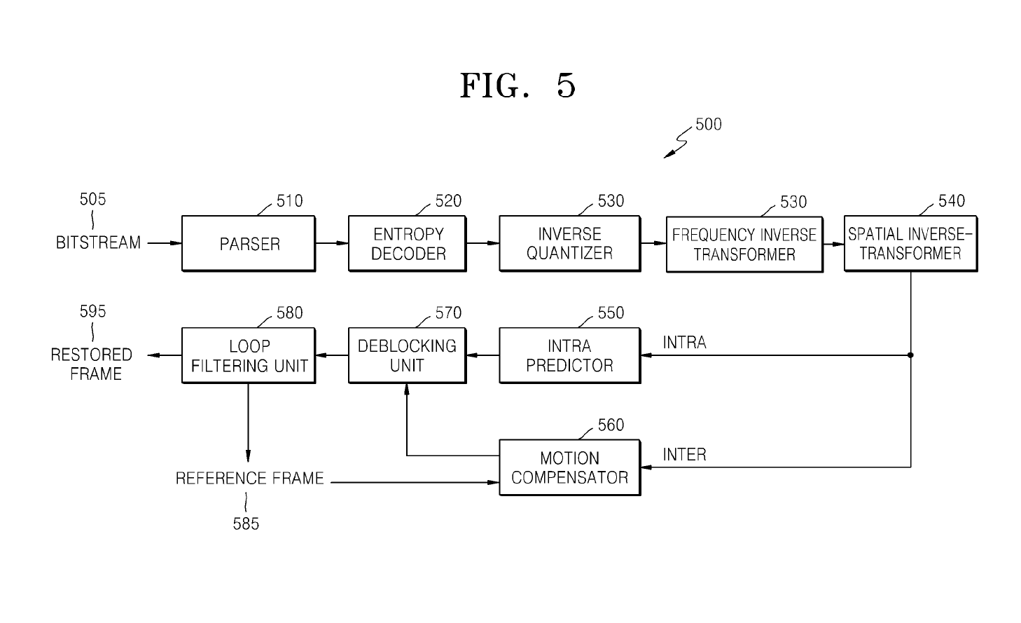

FIG. 5 is a block diagram of an image decoder 500 based on coding units, according to an exemplary embodiment.

Referring to FIG. 5, a parser 510 parses encoded image data to be decoded and encoding information required for decoding from a bitstream 505. The encoded image data is output as inverse quantized data through an entropy decoder 520 and an inverse quantizer 530. The inverse quantized data is transformed to a spatial domain through a frequency inverse transformer 535. A spatial inverse-transformer 540 spatially inverse-transforms an inverse-transformed residual block to have a size of the original residual block by using size information of the current residual block, which is decoded and extracted from the bitstream 505. In this case, the size information of the current residual block may be determined based on size information and depth information of a maximum decoding unit to which the current residual block belongs. A process of spatially inverse-transforming the residual values will be described in detail later.

The residual block that is spatially inverse-transformed to have the size of the original residual block added to the result of intra prediction of the intra predictor 550, or the result of motion compensation of a motion compensator 560, and is restored for each respective coding unit. The restored coding unit is used to perform prediction in a next coding unit or a next picture through a deblocking unit 570 and a loop filtering unit 580 to output a reference frame 585 or a restored frame 595.

In order to perform encoding by using an a video decoding method according to an exemplary embodiment, all elements of the image decoder 500, i.e., the parser 510, the entropy decoder 520, the inverse quantizer 530, the spatial inverse-transformer 540, the intra predictor 550, the motion compensator 560, the deblocking unit 570 and the loop filtering unit 580 may perform operations based on a maximum coding unit, a sub-coding unit according to depths, a prediction unit, and a transformation unit. Specifically, the intra predictor 550, and the motion compensator 560 may determine a prediction unit and a prediction mode in each coding unit while considering the maximum size and depth of each coding unit. The spatial inverse-transformer 540 may determine the size of the transformation unit while considering the maximum size and depth of each coding unit.

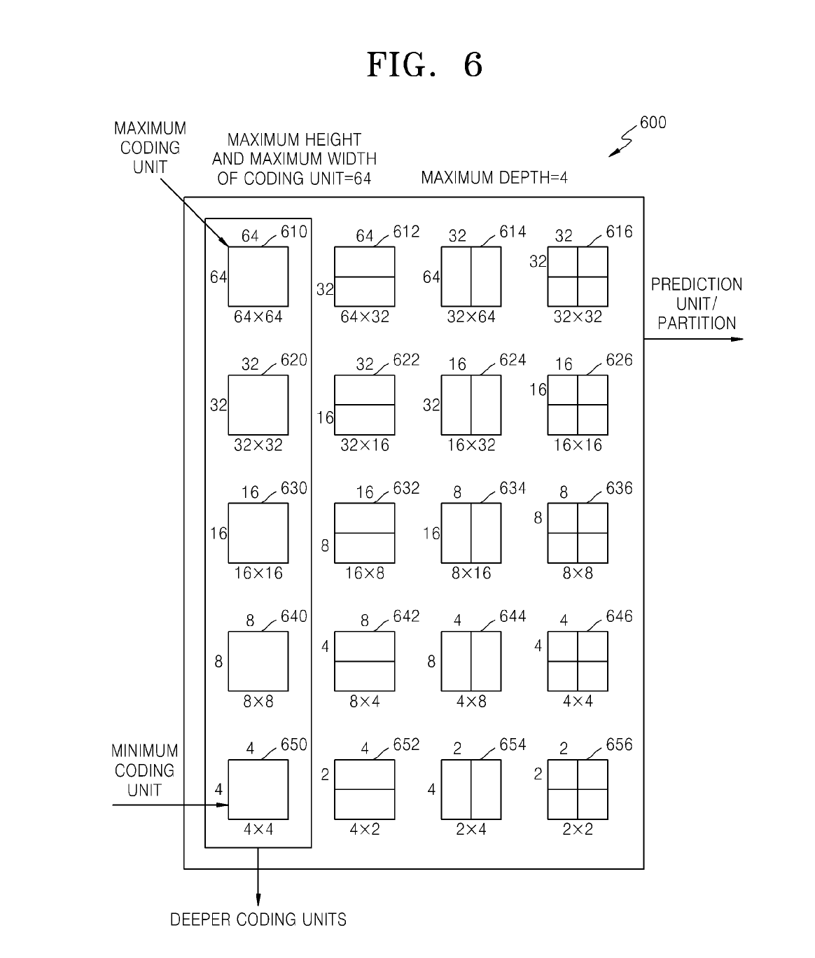

FIG. 6 is a diagram illustrating deeper coding units according to depths and partitions, according to an exemplary embodiment.

The video encoding apparatus 100 and the video decoding apparatus 200 use hierarchical coding units so as to consider characteristics of an image. A maximum height, a maximum width, and a maximum depth of coding units may be adaptively determined according to the characteristics of the image, or may be differently set by a user. Sizes of deeper coding units according to depths may be determined according to the predetermined maximum size of the coding unit.

In a hierarchical structure 600 of coding units, according to an exemplary embodiment, the maximum height and the maximum width of the coding units are each 64, and the maximum depth is 4. Since a depth deepens along a vertical axis of the hierarchical structure 600, a height and a width of the deeper coding unit are each split. Also, a prediction unit and partitions, which are bases for prediction encoding of each deeper coding unit, are shown along a horizontal axis of the hierarchical structure 600.

In other words, a coding unit 610 is a maximum coding unit in the hierarchical structure 600, where a depth is 0 and a size, i.e., a height by width, is 64×64. The depth deepens along the vertical axis, and a coding unit 620 having a size of 32×32 and a depth of 1, a coding unit 630 having a size of 16×16 and a depth of 2, a coding unit 640 having a size of 8×8 and a depth of 3, and a coding unit 650 having a size of 4×4 and a depth of 4 exist. The coding unit 650 having the size of 4×4 and the depth of 4 is a minimum coding unit.

The prediction unit and the partitions of a coding unit are arranged along the horizontal axis according to each depth. In other words, if the coding unit 610 having the size of 64×64 and the depth of 0 is a prediction unit, the prediction unit may be split into partitions included in the encoding unit 610, i.e. a partition 610 having a size of 64×64, partitions 612 having the size of 64×32, partitions 614 having the size of 32×64, or partitions 616 having the size of 32×32.

Similarly, a prediction unit of the coding unit 620 having the size of 32×32 and the depth of 1 may be split into partitions included in the coding unit 620, i.e. a partition 620 having a size of 32×32, partitions 622 having a size of 32×16, partitions 624 having a size of 16×32, and partitions 626 having a size of 16×16.

Similarly, a prediction unit of the coding unit 630 having the size of 16×16 and the depth of 2 may be split into partitions included in the coding unit 630, i.e. a partition having a size of 16×16 included in the coding unit 630, partitions 632 having a size of 16×8, partitions 634 having a size of 8×16, and partitions 636 having a size of 8×8.

Similarly, a prediction unit of the coding unit 640 having the size of 8×8 and the depth of 3 may be split into partitions included in the coding unit 640, i.e. a partition having a size of 8×8 included in the coding unit 640, partitions 642 having a size of 8×4, partitions 644 having a size of 4×8, and partitions 646 having a size of 4×4.

The coding unit 650 having the size of 4×4 and the depth of 4 is the minimum coding unit and a coding unit of the lowermost depth. A prediction unit of the coding unit 650 is only assigned to a partition having a size of 4×4.

In order to determine the at least one coded depth of the coding units constituting the maximum coding unit 610, the coding unit determiner 120 of the video encoding apparatus 100 performs encoding for coding units corresponding to each depth included in the maximum coding unit 610.

A number of deeper coding units according to depths including data in the same range and the same size increases as the depth deepens. For example, four coding units corresponding to a depth of 2 are required to cover data that is included in one coding unit corresponding to a depth of 1. Accordingly, in order to compare encoding results of the same data according to depths, the coding unit corresponding to the depth of 1 and four coding units corresponding to the depth of 2 are each encoded.

In order to perform encoding for a current depth from among the depths, a least encoding error may be selected for the current depth by performing encoding for each prediction unit in the coding units corresponding to the current depth, along the horizontal axis of the hierarchical structure 600. Alternatively, the minimum encoding error may be searched for by comparing the least encoding errors according to depths, by performing encoding for each depth as the depth deepens along the vertical axis of the hierarchical structure 600. A depth and a partition having the minimum encoding error in the coding unit 610 may be selected as the coded depth and a partition type of the coding unit 610.

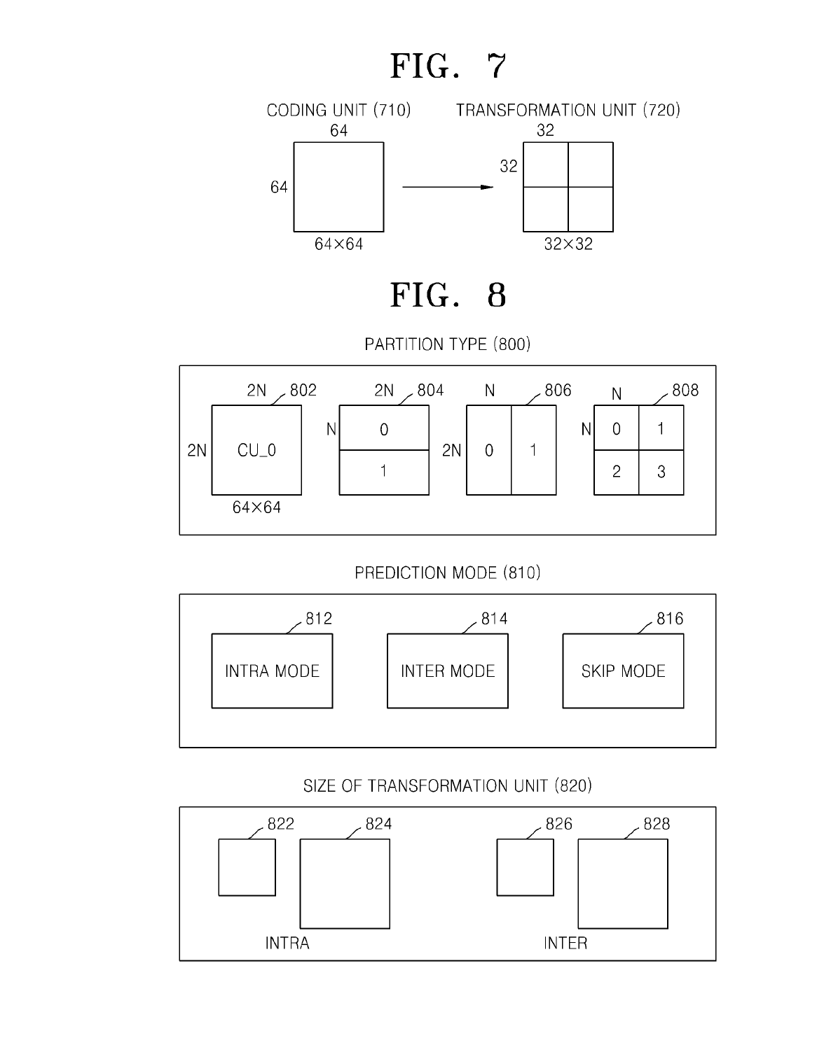

FIG. 7 is a diagram describing a relationship between a coding unit 710 and transformation units 720, according to an exemplary embodiment.

The video encoding apparatus 100 or 200 encodes or decodes an image according to coding units having sizes smaller than or equal to a maximum coding unit for each maximum coding unit. Sizes of transformation units for transformation during encoding may be selected based on data units that are not larger than a corresponding coding unit.

For example, in the video encoding apparatus 100 or 200, if a size of the coding unit 710 is 64×64, transformation may be performed by using the transformation units 720 having a size of 32×32.

Also, data of the coding unit 710 having the size of 64×64 may be encoded by performing the transformation on each of the transformation units having the size of 32×32, 16×16, 8×8, and 4×4, which are smaller than 64×64, and then a transformation unit having the least coding error may be selected.

FIG. 8 is a diagram describing encoding information of coding units corresponding to a coded depth, according to an exemplary embodiment.

The output unit 130 of the video encoding apparatus 100 may encode and transmit information 800 about a partition type, information 810 about a prediction mode, and information 820 about a size of a transformation unit for each coding unit corresponding to a coded depth, as information about an encoding mode.

The information 800 indicates information about a shape of a partition obtained by splitting a prediction unit of a current coding unit, where the partition is a data unit for prediction encoding the current coding unit. For example, a current coding unit CU_0 having a size of 2N×2N may be split into any one of a partition 802 having a size of 2N×2N, a partition 804 having a size of 2N×N, a partition 806 having a size of N×2N, and a partition 808 having a size of N×N. Here, the information 800 about a partition type is set to indicate one of the partition 804 having a size of 2N×N, the partition 806 having a size of N×2N, and the partition 808 having a size of N×N.

The information 810 indicates a prediction mode of each partition. For example, the information 810 may indicate a mode of prediction encoding performed on a partition indicated by the information 800, i.e., an intra mode 812, an inter mode 814, or a skip mode 816.

The information 820 indicates a transformation unit to be based on when transformation is performed on a current coding unit. For example, the transformation unit may be a first intra transformation unit 822, a second intra transformation unit 824, a first inter transformation unit 826, or a second inter transformation unit 828.

The image data and encoding information extractor 220 of the video decoding apparatus 200 may extract and use the information 800, 810, and 820 for decoding, according to each deeper coding unit.

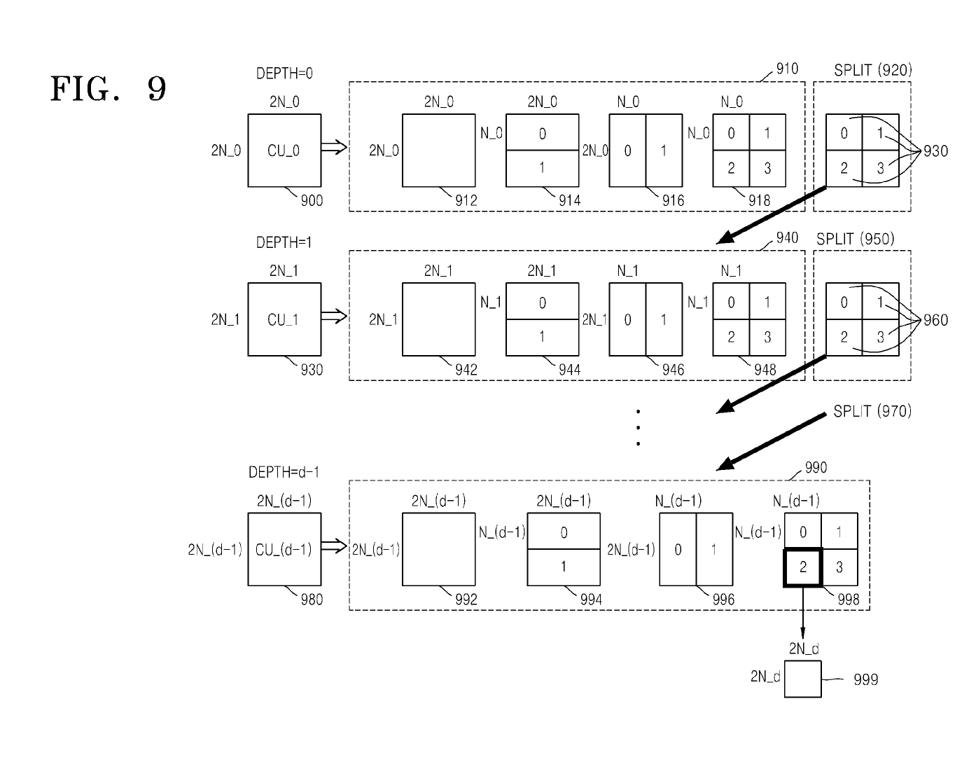

FIG. 9 is a diagram of deeper coding units according to depths, according to an exemplary embodiment.

Split information may be used to indicate a change of a depth. The spilt information indicates whether a coding unit of a current depth is split into coding units of a lower depth.

A prediction unit 910 for prediction encoding a coding unit 900 having a depth of 0 and a size of 2N_{—}0×2N_{—}0 may include partitions of a partition type 912 having a size of 2N_{—}0×2N_{—}0, a partition type 914 having a size of 2N_{—}0×N_{—}0, a partition type 916 having a size of N_{—}0×2N_{—}0, and a partition type 918 having a size of N_{—}0×N_{—}0. FIG. 9 only illustrates the partition types 912 through 918 which are obtained by symmetrically splitting the prediction unit 910, but a partition type is not limited thereto, and the partitions of the prediction unit 910 may include asymmetrical partitions, partitions having a predetermined shape, and partitions having a geometrical shape.

Prediction encoding is repeatedly performed on one partition having a size of 2N_{—}0×2N_{—}0, two partitions having a size of 2N_{—}0×N_{—}0, two partitions having a size of N_{—}0×2N_{—}0, and four partitions having a size of N_{—}0×N_{—}0, according to each partition type. The prediction encoding in an intra mode and an inter mode may be performed on the partitions having the sizes of 2N_{—}0×2N_{—}0, N_{—}0×2N_{—}0, 2N_{—}0×N_{—}0, and N_{—}0×N_{—}0. The prediction encoding in a skip mode is performed only on the partition having the size of 2N_{—}0×2N_{—}0.

Errors of encoding including the prediction encoding in the partition types 912 through 918 are compared, and the least encoding error is determined among the partition types. If an encoding error is smallest in one of the partition types 912 through 916, the prediction unit 910 may not be split into a lower depth.

If the encoding error is the smallest in the partition type 918, a depth is changed from 0 to 1 to split the partition type 918 in operation 920, and encoding is repeatedly performed on coding units 930 having a depth of 2 and a size of N_{—}0×N_{—}0 to search for a minimum encoding error.

A prediction unit 940 for prediction encoding the coding unit 930 having a depth of 1 and a size of 2N_{—}1×2N_{—}1 (=N_{—}0×N_{—}0) may include partitions of a partition type 942 having a size of 2N_{—}1×2N_{—}1, a partition type 944 having a size of 2N_{—}1×N_{—}1, a partition type 946 having a size of N_{—}1×2N_{—}1, and a partition type 948 having a size of N_{—}1×N_{—}1.

If an encoding error is the smallest in the partition type 948, a depth is changed from 1 to 2 to split the partition type 948 in operation 950, and encoding is repeatedly performed on coding units 960, which have a depth of 2 and a size of N_{—}2×N_{—}2 to search for a minimum encoding error.

When a maximum depth is d, split operation according to each depth may be performed up to when a depth becomes d-1, and split information may be encoded as up to when a depth is one of 0 to d-2. In other words, when encoding is performed up to when the depth is d-1 after a coding unit corresponding to a depth of d-2 is split in operation 970, a prediction unit 990 for prediction encoding a coding unit 980 having a depth of d-1 and a size of 2N_(d-1)×2N_(d-1) may include partitions of a partition type 992 having a size of 2N_(d-1)×2N_(d-1), a partition type 994 having a size of 2N_(d-1)×N_(d-1), a partition type 996 having a size of N_(d-1)×2N_(d-1), and a partition type 998 having a size of N_(d-1)×N_(d-1).

Prediction encoding may be repeatedly performed on one partition having a size of 2N_(d-1)×2N_(d-1), two partitions having a size of 2N_(d-1)×N_(d-1), two partitions having a size of N_(d-1)×2N_(d-1), four partitions having a size of N_(d-1)×N_(d-1) from among the partition types 992 through 998 to search for a partition type having a minimum encoding error.

Even when the partition type 998 has the minimum encoding error, since a maximum depth is d, a coding unit CU_(d-1) having a depth of d-1 is no longer split to a lower depth, and a coded depth for the coding units constituting a current maximum coding unit 900 is determined to be d-1 and a partition type of the current maximum coding unit 900 may be determined to be N_(d-1)×N_(d-1). Also, since the maximum depth is d and a minimum coding unit 980 having a lowermost depth of d-1 is no longer split to a lower depth, split information for the minimum coding unit 980 is not set.

A data unit 999 may be a ‘minimum unit’ for the current maximum coding unit. A minimum unit according to an exemplary embodiment may be a rectangular data unit obtained by splitting a minimum coding unit 980 by 4. By performing the encoding repeatedly, the video encoding apparatus 100 may select a depth having the least encoding error by comparing encoding errors according to depths of the coding unit 900 to determine a coded depth, and set a corresponding partition type and a prediction mode as an encoding mode of the coded depth.

As such, the minimum encoding errors according to depths are compared in all of the depths of 1 through d, and a depth having the least encoding error may be determined as a coded depth. The coded depth, the partition type of the prediction unit, and the prediction mode may be encoded and transmitted as information about an encoding mode. Also, since a coding unit is split from a depth of 0 to a coded depth, only split information of the coded depth is set to 0, and split information of depths excluding the coded depth is set to 1.

The image data and encoding information extractor 220 of the video decoding apparatus 200 may extract and use the information about the coded depth and the prediction unit of the coding unit 900 to decode the partition 912. The video decoding apparatus 200 may determine a depth, in which split information is 0, as a coded depth by using split information according to depths, and use information about an encoding mode of the corresponding depth for decoding.

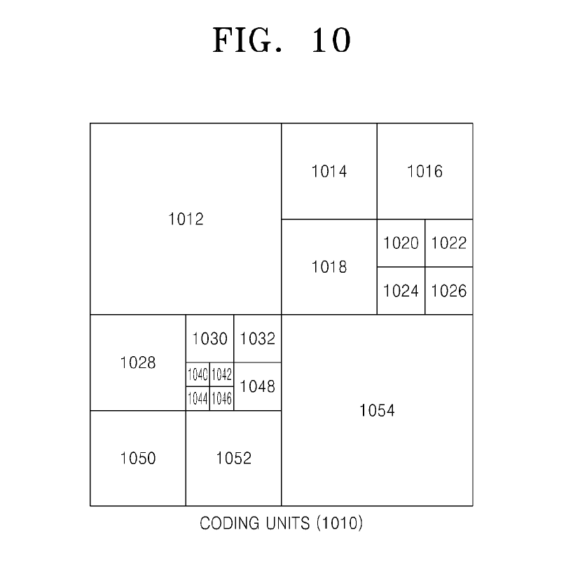

FIGS. 10 through 12 are diagrams for describing a relationship between coding units 1010, prediction units 1060, and transformation units 1070, according to an exemplary embodiment.

The coding units 1010 are coding units having a tree structure, corresponding to coded depths determined by the video encoding apparatus 100, in a maximum coding unit. The prediction units 1060 are partitions of prediction units of each of the coding units 1010, and the transformation units 1070 are transformation units of each of the coding units 1010.

When a depth of a maximum coding unit is 0 in the coding units 1010, depths of coding units 1012 and 1054 are 1, depths of coding units 1014, 1016, 1018, 1028, 1050, and 1052 are 2, depths of coding units 1020, 1022, 1024, 1026, 1030, 1032, and 1048 are 3, and depths of coding units 1040, 1042, 1044, and 1046 are 4.

In the prediction units 1060, some encoding units 1014, 1016, 1022, 1032, 1048, 1050, 1052, and 1054 are obtained by splitting the coding units in the encoding units 1010. In other words, partition types in the coding units 1014, 1022, 1050, and 1054 have a size of 2N×N, partition types in the coding units 1016, 1048, and 1052 have a size of N×2N, and a partition type of the coding unit 1032 has a size of N×N. Prediction units and partitions of the coding units 1010 are smaller than or equal to each coding unit.

Transformation or inverse transformation is performed on image data of the coding unit 1052 in the transformation units 1070 in a data unit that is smaller than the coding unit 1052. Also, the coding units 1014, 1016, 1022, 1032, 1048, 1050, and 1052 in the transformation units 1070 are different from those in the prediction units 1060 in terms of sizes and shapes. In other words, the video encoding and decoding apparatuses 100 and 200 may perform intra prediction, motion estimation, motion compensation, transformation, and inverse transformation individually on a data unit in the same coding unit.

Accordingly, encoding is recursively performed on each of coding units having a hierarchical structure in each region of a maximum coding unit to determine an optimum coding unit, and thus coding units having a recursive tree structure may be obtained. Encoding information may include split information about a coding unit, information about a partition type, information about a prediction mode, and information about a size of a transformation unit. Table 1 shows the encoding information that may be set by the video encoding and decoding apparatuses 100 and 200.

TABLE 1

| Split Information 0 | | | | | |
|---|---|---|---|---|---|
| (Encoding on Coding Unit having Size of 2N × 2N and Current Depth of d) | | | | | Split Information 1 |
| Prediction Mode | Partition Type | | Size of Transformation Unit | | Repeatedly |
| Intra | Symmetrical | Asymmetrical | Split Information 0 | Split Information 1 | Encode |
| Inter | Partition | Partition | of Transformation | of Transformation | Coding |
| Skip (Only | Type | Type | Unit | Unit | Units |
| 2N × 2N) | 2N × 2N | 2N × nU | 2N × 2N | N × N | having |
| | 2N × N | 2N × nD | | (Symmetrical | Lower |
| | N × 2N | nL × 2N | | Type) | Depth of |
| | N × N | nR × 2N | | N/2 × N/2 | d + 1 |
| | | | | (Asymmetrical | |
| | | | | Type) | |

The output unit 130 of the video encoding apparatus 100 may output the encoding information about the coding units having a tree structure, and the image data and encoding information extractor 220 of the video decoding apparatus 200 may extract the encoding information about the coding units having a tree structure from a received bitstream.

Split information indicates whether a current coding unit is split into coding units of a lower depth. If split information of a current depth d is 0, a depth, in which a current coding unit is no longer split into a lower depth, is a coded depth, and thus information about a partition type, prediction mode, and a size of a transformation unit may be defined for the coded depth. If the current coding unit is further split according to the split information, encoding is independently performed on four split coding units of a lower depth.

A prediction mode may be one of an intra mode, an inter mode, and a skip mode. The intra mode and the inter mode may be defined in all partition types, and the skip mode is defined only in a partition type having a size of 2N×2N.

The information about the partition type may indicate symmetrical partition types having sizes of 2N×2N, 2N×N, N×2N, and N×N, which are obtained by symmetrically splitting a height or a width of a prediction unit, and asymmetrical partition types having sizes of 2N×nU, 2N×nD, nL×2N, and nR×2N, which are obtained by asymmetrically splitting the height or width of the prediction unit. The asymmetrical partition types having the sizes of 2N×nU and 2N×nD may be respectively obtained by splitting the height of the prediction unit in 1:3 and 3:1, and the asymmetrical partition types having the sizes of nL×2N and nR×2N may be respectively obtained by splitting the width of the prediction unit in 1:3 and 3:1.

The size of the transformation unit may be set to be two types in the intra mode and two types in the inter mode. In other words, if split information of the transformation unit is 0, the size of the transformation unit may be 2N×2N, which is the size of the current coding unit. If split information of the transformation unit is 1, the transformation units may be obtained by splitting the current coding unit. Also, if a partition type of the current coding unit having the size of 2N×2N is a symmetrical partition type, a size of a transformation unit may be N×N, and if the partition type of the current coding unit is an asymmetrical partition type, the size of the transformation unit may be N/2×N/2.

The encoding information about coding units having a tree structure may include at least one of a coding unit corresponding to a coded depth, a prediction unit, and a minimum unit. The coding unit corresponding to the coded depth may include at least one of a prediction unit and a minimum unit containing the same encoding information.

Accordingly, it is determined whether adjacent data units are included in the same coding unit corresponding to the coded depth by comparing encoding information of the adjacent data units. Also, a corresponding coding unit corresponding to a coded depth is determined by using encoding information of a data unit, and thus a distribution of coded depths in a maximum coding unit may be determined.

Accordingly, if a current coding unit is predicted based on encoding information of adjacent data units, encoding information of data units in deeper coding units adjacent to the current coding unit may be directly referred to and used.

Alternatively, if a current coding unit is predicted based on encoding information of adjacent data units, data units adjacent to the current coding unit are searched using encoding information of the data units, and the searched adjacent coding units may be referred for predicting the current coding unit.

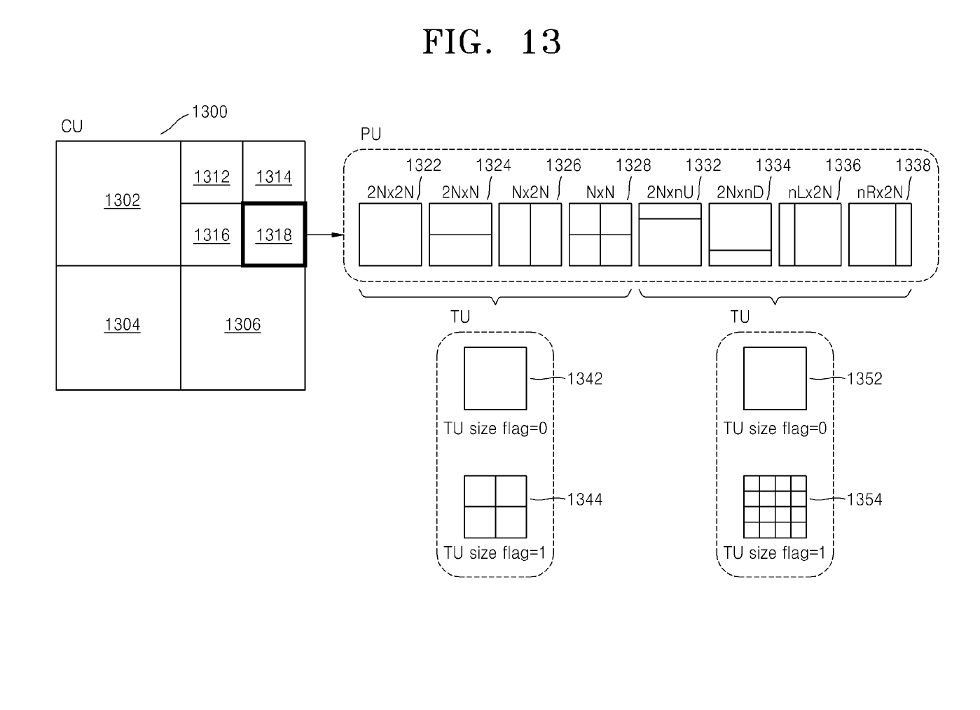

FIG. 13 is a diagram describing a relationship between a coding unit, a prediction unit or a partition, and a transformation unit, according to encoding mode information.

According to an exemplary embodiment, FIG. 13 illustrates a relationship between a coding unit, a prediction unit or a partition, and a transformation unit according to the encoding mode information of Table 1. A maximum coding unit 1300 includes coding units 1302, 1304, 1306, 1312, 1314, 1316, and 1318 of coded depths. Here, since the coding unit 1318 is a coding unit of a coded depth, split information may be set to 0. Information about a partition type of the coding unit 1318 having a size of 2N×2N may be set to be one of a partition type 1322 having a size of 2N×2N, a partition type 1324 having a size of 2N×N, a partition type 1326 having a size of N×2N, a partition type 1328 having a size of N×N, a partition type 1332 having a size of 2N×nU, a partition type 1334 having a size of 2N×nD, a partition type 1336 having a size of nL×2N, and a partition type 1338 having a size of nR×2N.

When the partition type is set to be symmetrical, i.e. the partition type 1322, 1324, 1326, or 1328, a transformation unit 1342 having a size of 2N×2N is set if split information (TU size flag) of a transformation unit is 0, and a transformation unit 1344 having a size of N×N is set if a TU size flag is 1.

When the partition type is set to be asymmetrical, i.e., the partition type 1332, 1334, 1336, or 1338, a transformation unit 1352 having a size of 2N×2N is set if a TU size flag is 0, and a transformation unit 1354 having a size of N/2×N/2 is set if a TU size flag is 1.

Referring to FIG. 13, the TU size flag is a flag having a value or 0 or 1, but the TU size flag is not limited to 1 bit, and a transformation unit may be hierarchically split having a tree structure while the TU size flag increases from 0.

In this case, the size of a transformation unit that has been actually used may be expressed by using a TU size flag of a transformation unit, according to an exemplary embodiment, together with a maximum size and minimum size of the transformation unit. According to an exemplary embodiment, the video encoding apparatus 100 is capable of encoding maximum transformation unit size information, minimum transformation unit size information, and a maximum TU size flag. The result of encoding the maximum transformation unit size information, the minimum transformation unit size information, and the maximum TU size flag may be inserted into an SPS. According to an exemplary embodiment, the video decoding apparatus 200 may decode video by using the maximum transformation unit size information, the minimum transformation unit size information, and the maximum TU size flag.

For example, if the size of a current coding unit is 64×64 and a maximum transformation unit size is 32×32, then the size of a transformation unit may be 32×32 when a TU size flag is 0, may be 16×16 when the TU size flag is 1, and may be 8×8 when the TU size flag is 2.

As another example, if the size of the current coding unit is 32×32 and a minimum transformation unit size is 32×32, then the size of the transformation unit may be 32×32 when the TU size flag is 0. Here, the TU size flag cannot be set to a value other than 0, since the size of the transformation unit cannot be less than 32×32.

As another example, if the size of the current coding unit is 64×64 and a maximum TU size flag is 1, then the TU size flag may be 0 or 1. Here, the TU size flag cannot be set to a value other than 0 or 1.

Thus, if it is defined that the maximum TU size flag is ‘MaxTransformSizeIndex’, a minimum transformation unit size is ‘MinTransformSize’, and a transformation unit size is ‘RootTuSize’ when the TU size flag is 0, then a current minimum transformation unit size ‘CurrMinTuSize’ that can be determined in a current coding unit, may be defined by Equation (1):

CurrMinTuSize=max(MinTransformSize, RootTuSize/(2̂MaxTransformSizeIndex)) (1)

Compared to the current minimum transformation unit size ‘CurrMinTuSize’ that can be determined in the current coding unit, a transformation unit size ‘RootTuSize’ when the TU size flag is 0 may denote a maximum transformation unit size that can be selected in the system. In Equation (1), ‘RootTuSize/(2̂MaxTransformSizeIndex)’ denotes a transformation unit size when the transformation unit size ‘RootTuSize’, when the TU size flag is 0, is split a number of times corresponding to the maximum TU size flag, and ‘MinTransformSize’ denotes a minimum transformation size. Thus, a smaller value from among ‘RootTuSize/(2̂MaxTransformSizeIndex)’ and ‘MinTransformSize’ may be the current minimum transformation unit size ‘CurrMinTuSize’ that can be determined in the current coding unit.

According to an exemplary embodiment, the maximum transformation unit size RootTuSize may vary according to the type of a prediction mode.

For example, if a current prediction mode is an inter mode, then ‘RootTuSize’ may be determined by using Equation (2) below. In Equation (2), ‘MaxTransformSize’ denotes a maximum transformation unit size, and ‘PUSize’ denotes a current prediction unit size.

RootTuSize=min(MaxTransformSize, PUSize) (2)

That is, if the current prediction mode is the inter mode, the transformation unit size ‘RootTuSize’ when the TU size flag is 0, may be a smaller value from among the maximum transformation unit size and the current prediction unit size.

If a prediction mode of a current partition unit is an intra mode, ‘RootTuSize’ may be determined by using Equation (3) below. In Equation (3), ‘PartitionSize’ denotes the size of the current partition unit.

RootTuSize=min(MaxTransformSize, PartitionSize) (3)

That is, if the current prediction mode is the intra mode, the transformation unit size ‘RootTuSize’ when the TU size flag is 0 may be a smaller value from among the maximum transformation unit size and the size of the current partition unit.

However, the current maximum transformation unit size ‘RootTuSize’ that varies according to the type of a prediction mode in a partition unit is just an example.

Hereinafter, a process of spatially transforming or inverse-transforming a residual block performed by the spatial transformer 415 of FIG. 4 and the spatial inverse-transformer 540 of FIG. 5 will now be described in detail.

FIG. 14 is a reference diagram describing a process of spatially transforming a current residual block 1410, according to an exemplary embodiment.

Typically, if the current residual block 1410 has a size of 2N×2N, and the maximum size of an available transformation unit is N×N, the current residual block 1410 is split into four N×N blocks, and then frequency transformation is performed on each of the four N×N blocks. According to an exemplary embodiment, when the size of the current residual block 1410 is larger than the maximum size of the available transformation unit, wavelet transformation is performed on the current residual block 1410 instead of splitting the current residual block 1410. In the wavelet transformation, spatial transformation is performed so that a size of a predetermined sub-band may be equal to or smaller than the maximum size of the transformation unit, and frequency transformation is performed on the selected predetermined sub-band. In this case, if the predetermined sub-band is a flat image, the predetermined sub-band may be a low frequency sub-band.

Referring to FIG. 14, the spatial transformer 415 splits the current residual block 1410 having a size of 2N×2N into sub-bands through the wavelet transformation. The sub-bands include horizontal, vertical, and diagonal sub-bands. A low frequency sub-band 1421, that is, a sub-band having a low frequency with respect to horizontal and vertical directions is referred to as “LL”. A high frequency sub-band 1422, 1423, and 1424 are respectively referred to as “LH”, “HL”, or “HH”, which indicates high frequency sub-bands with respect to a horizontal direction, a vertical direction, and horizontal and vertical directions, respectively. A right number of each sub-band indicates a level of the wavelet transformation, and indicates a level of wavelet transformation through which a corresponding sub-band is generated.

A level in which the wavelet transformation is performed may be determined based on the size of the current residual block 1410 and the maximum size of the available transformation unit. In detail, when the wavelet transformation is performed on a residual block having a size of b×b in an ‘a’ level, a low frequency sub-band ‘LLa’ generated by performing the wavelet in the ‘a’ level has a size of (b/2a)×(b/2a). Thus, a level in which the wavelet transformation is performed may be determined by calculating an ‘a’ value so that (b/2a)×(b/2a) indicating the size of the low frequency sub-band on which the wavelet transformation is performed in the ‘a’ level may be smaller than the maximum size of the available transformation unit. For example, as illustrated in FIG. 14, if the current residual block 1410 has the size of 2N×2N, and the maximum size of the transformation unit is N×N, the size of any sub-band may be equal to or smaller than the maximum size of the transformation unit of N×N through first level wavelet transformation. If the maximum size of the transformation unit is (N/2)×(N/2), when second level wavelet transformation is performed, the size of the low frequency sub-bands LL2 1431 and high frequency sub-bands LH2 1432, HL2 1433, and HH2 1434 is equal to or smaller than the maximum size of the transformation unit of (N/2)×(N/2).

Likewise, the wavelet transformation is performed until the size of a predetermined sub-band, that is, the low frequency sub band is equal to or smaller than the maximum size of the transformation unit. This is because only a low frequency sub-band is spatially transformed so as to be proper to the size of the available transformation unit, instead of frequency-transforming a high frequency sub-band, since most image data components are concentrated on a low frequency sub-band in the case of a flat image.

FIG. 15 is a block diagram of a spatial transformer 1500, according to an exemplary embodiment. The spatial transformer 1500 of FIG. 15 corresponds to the spatial transformer 415 of FIG. 4.

Referring to FIG. 15, the spatial transformer 1500 includes a wavelet transformer 1510 and an upscaler 1520.

As described above, when the size of a current residual block is smaller than the maximum size of the available transformation unit, the wavelet transformer 1510 performs wavelet transformation on the current residual block, in which spatial transformation is performed so that a size of a predetermined sub-band may be equal to or smaller than the maximum size of a transformation unit, and performs frequency transformation on the selected predetermined sub-band.

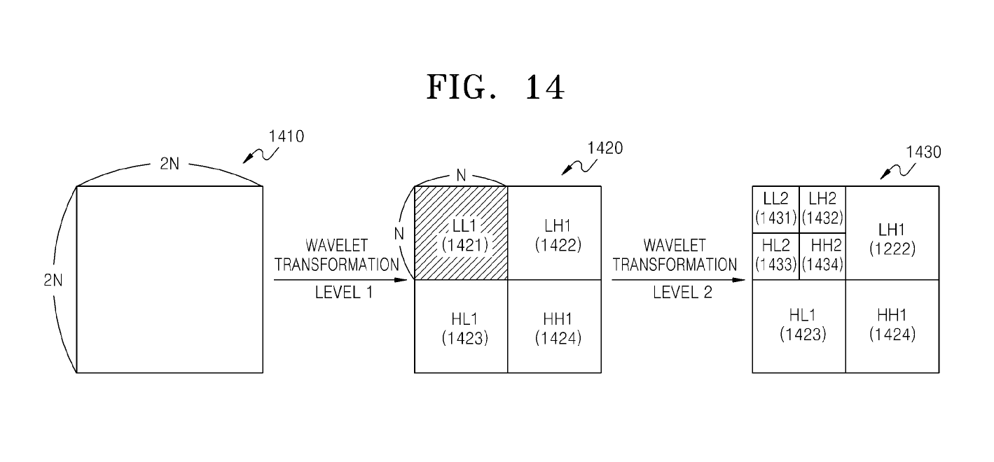

FIG. 16 is a diagram for describing a method of wavelet transformation, according to an exemplary embodiment.

Referring to FIG. 16, each row of a residual block is filtered by a low-pass filter Lx 1610 and a high-pass filter Hx 1611. The filtered output value is ½ down-sampled by down samplers 1612 and 1613 to generate intermediate images L 1615 and H 1616. The intermediate image L 1615 corresponds to data that is formed by low-pass filtering the residual block and then down-sampling the residual block in an x-axis direction. The intermediate image H 1616 corresponds to data that is formed by high-pass filtering the residual block and then down-sampling the residual block in the x-axis direction. Then, each row of the intermediate image L 1615 and each row of the intermediate image H 1616 are filtered by low-pass filters Ly 1617 and 1619, and high-pass filters Hy 1618 and 1620. Each filtered output value is ½ down-sampled by down samplers 1621 through 1624 to generate four sub-bands LL, LH, HL, and HH. The four sub-bands are combined to generate a single piece of data having samples having the same number as the original residual blocks. To perform the wavelet transformation, various filters with properties varying according to their coefficients, such as Haar, 5/3, 9/7, 11/13, may be used.

Referring back to FIG. 15, the upscaler 1520 generates a sub-band that is scaled by multiplying a predetermined sub-band generated through the wavelet transformation by a predetermined weight. As described above, the predetermined sub-band may be a low frequency sub-band. As illustrated in FIG. 16, during the wavelet transformation, discrete signals having n samples are filtered into a low frequency band and a high frequency band by a pair of filters. Since each of the low frequency band and the high frequency band is sub-sampled by a component ‘2’, each of the low frequency band and the high frequency band includes n/2 samples. Thus, prior to performing frequency transformation, the upscaler 1520 multiplies a predetermined sub-band generated through the wavelet transformation by a predetermined weight so that a resulting value on which the frequency transformation is performed on only the predetermined sub-band may be similar to a resulting value on which the frequency transformation is performed on the original residual block. In this case, the weight may be 2̂N (where N is a positive integer) when N level wavelet transformation is performed on a residual block. For example, when 1 level wavelet transformation is performed on a residual block, the upscaler 1520 multiplies each coefficient of a low frequency sub-band LL1 generated through the 1 level wavelet transformation by a weight of 2 to generate a scaled sub-band.

Likewise, frequency transformation, quantization, and entropy encoding are performed on a predetermined sub-band on which wavelet transformation and upscaling are performed by the spatial transformer 1500 of FIG. 15 to generate a bitstream.

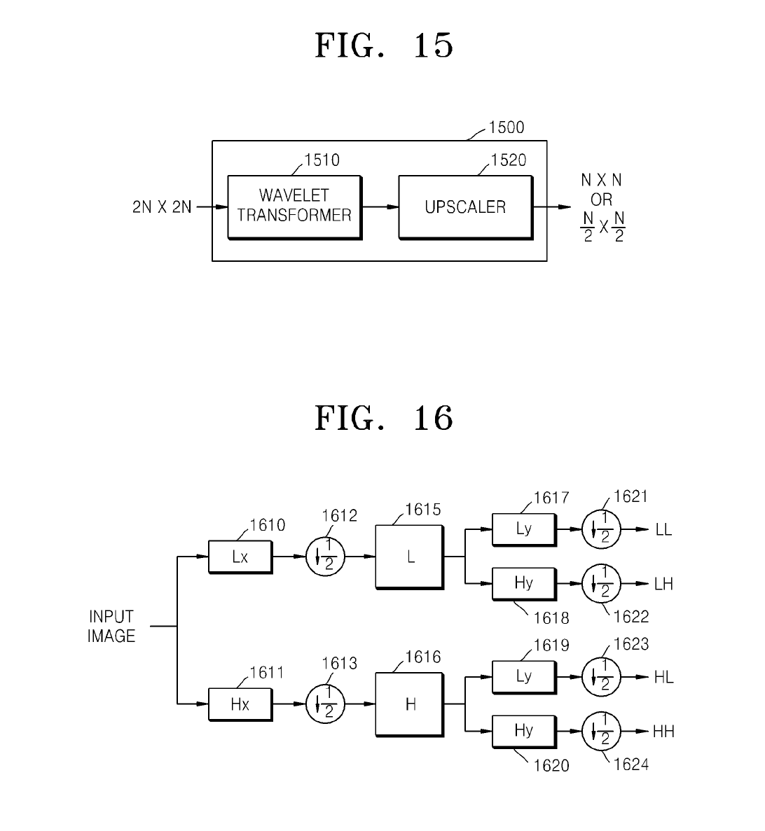

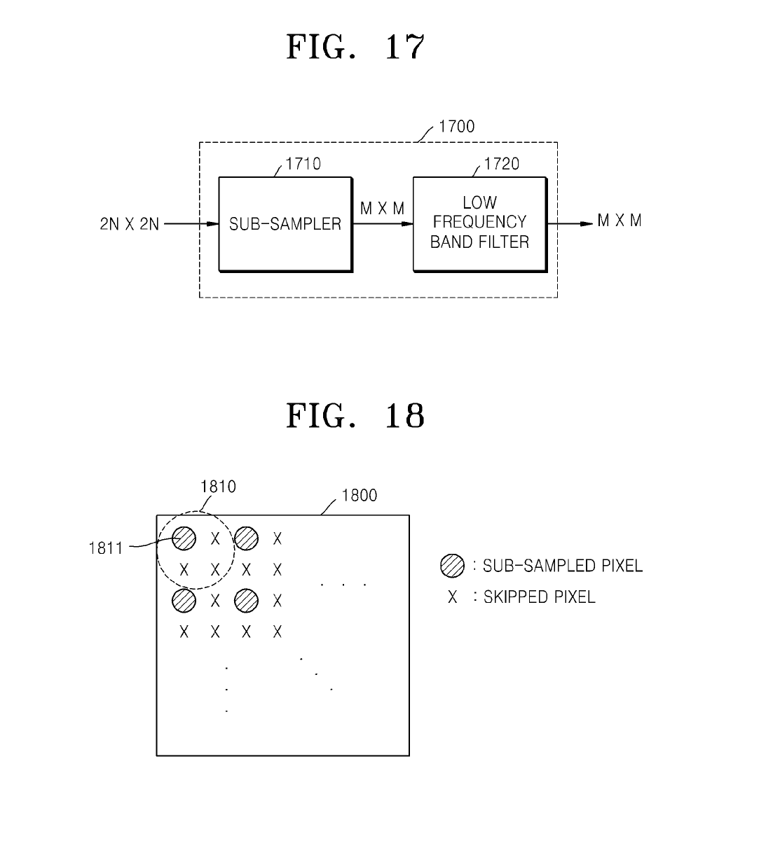

FIG. 17 is a block diagram of a spatial transformer 1700, according to an exemplary embodiment.

Referring to FIG. 17, the spatial transformer 1700 includes a sub-sampler 1710 and a low frequency band filter 1720.

When a size of a current residual block is larger than the maximum size of an available transformation unit, the sub-sampler 1710 sub-samples the current residual block, and transforms the current residual block to have a size that is equal to or smaller than the maximum size of the transformation unit. For example, when the current residual block has a size of 2N×2N, and the maximum size of the transformation unit is M×M, the sub-sampler 1710 spatially transforms the size of the current residual block into a size of M×M through sub-sampling in which some pixels are selected from among pixels constituting the current residual block.

FIG. 18 is reference describing a process of sub-sampling performed in the spatial transformer 1700 of FIG. 17, according to an exemplary embodiment.

Referring to FIG. 18, when a current residual block 1800 has a size of 2N×2N, and the maximum size of an available transformation unit is (N/2)×(N/2), one pixel 1811 from among four adjacent pixels 1810 is sampled so that the size of the current residual block 1800 may be equal to or smaller than (N/2)×(N/2). When a size of a current residual block is C×C, and the maximum size of the transformation unit is D×D Spatial transformation using this sub-sampling may be performed by sampling a pixel in the current residual block in a ratio of 1:((C×C)/(D×D)).

Referring back to FIG. 17, the low frequency band filter 1720 performs low frequency band filtering on a spatially transformed residual block so as to have a size that is equal to or smaller than the maximum size of the transformation unit by the sub-sampler 1710, in order to remove high frequency components that may be generated during sub-sampling.

As described above, according to one or more exemplary embodiments, instead of splitting a residual block to each have a size of an available transformation unit and performing frequency transformation like a prior art, the residual block is spatially transformed so as to have a size that is equal to or smaller than the maximum size of a transformation unit through spatial transformation, and then frequency transformation is performed on the spatially transformed residual block. Specifically, with regard to a flat image having a large size, when the size of the available transformation unit does not reach the size of a coding unit, since frequency transformation is performed only a single time on the spatially transformed coding unit, the number of calculation processes may be reduced, and an image compression efficiency may be increased.

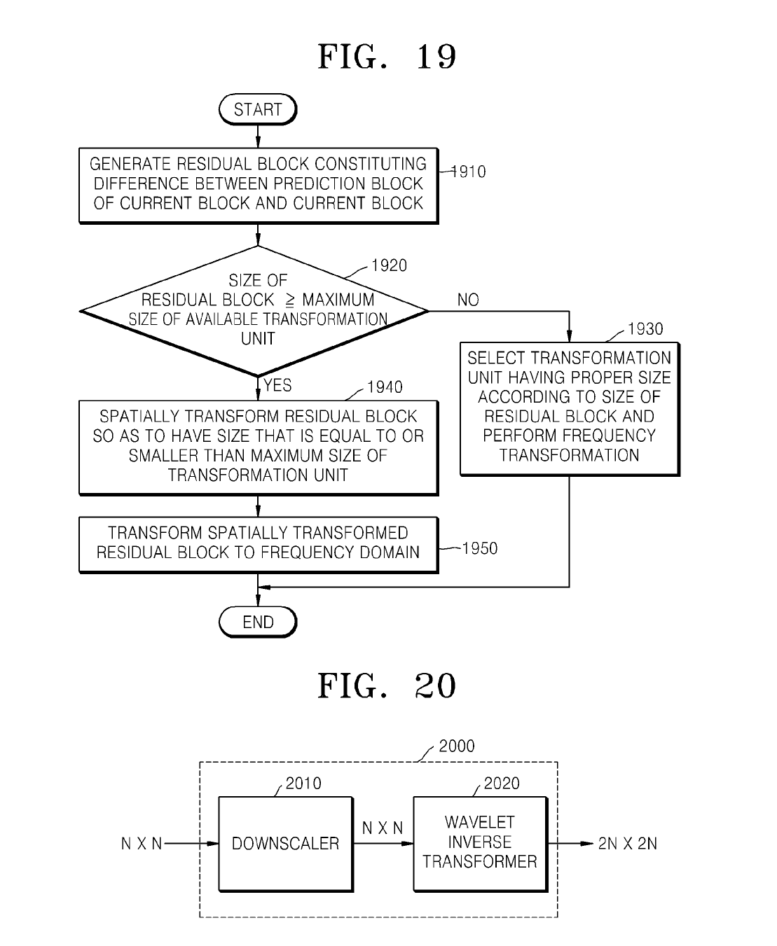

FIG. 19 is a flowchart of an image encoding method according to an exemplary embodiment.

In operation 1910, a residual block constituting a difference between a prediction block of a current block and the current block is generated.

In operation 1920, a size of the residual block is compared with the maximum size of an available transformation unit. As a result of the comparison of operation 1920, when the size of the residual block is not larger than the maximum size of the transformation unit, a transformation unit having a proper size is selected according to the size of the residual block, and then frequency transformation is performed, in operation 1930.

As the result of the comparison of operation 1920, when the size of the residual block is larger than the maximum size of the transformation unit, the residual block is spatially transformed to have a size that is equal to or smaller than the maximum size of the transformation unit, in operation 1940. As described above, spatial transformation may be performed by selecting a predetermined sub-band generated through wavelet transformation, or by performing sub-sampling. When the spatial transformation is performed through the wavelet transformation, the predetermined sub-band may be multiplied by a predetermined weight. When the spatial transformation is performed through the sub-sampling, low frequency band filtering may be performed.

In operation 1950, the spatially transformed residual block is transformed to a frequency domain. In order to transform the residual block into the frequency domain, discrete cosine transform may be used.

FIG. 20 is a block diagram of a spatial inverse-transformer 2000 according to an exemplary embodiment. The spatial inverse-transformer 2000 of FIG. 20 corresponds to the spatial inverse-transformer 540 of FIG. 5. As described above, the parser 510 of FIG. 5 extracts size information of the current residual block, which is decoded from a bitstream and information about encoded residual block. In this case, the size information of the current residual block may include size information and depth information of a maximum coding unit. The information about the encoded residual block is inverse-quantized and inverse-transformed by the entropy decoder 520, an inverse quantizer 530 and the frequency inverse transformer 535, and is transformed from a frequency domain to a spatial domain. Such residual data that is transformed to the spatial domain is input to the spatial inverse-transformer 2000.

Referring to FIG. 20, the spatial inverse-transformer 2000 includes a downscaler 2010, and a wavelet inverse transformer 2020.

The downscaler 2010 performs inverse-scaling of dividing the inversely transformed residual block by a predetermined weight, which is an inverse process of upscaling performed by the upscaler 1520 of FIG. 15. In this case, the residual block that is inversely transformed to the spatial domain corresponds to the low frequency sub-band of the wavelet-transformed residual block, which is generated by the wavelet transformer 1510 of FIG. 14. When the downscaler 2010 performs downscaling, the low frequency sub-band prior to upscaling is obtained.

The wavelet inverse transformer 2020 performs wavelet inverse transformation on the downscaled low frequency sub-band to perform space inverse transformation of enlarging the size of the residual block to the size of the original residual block. For example, when the size of the residual block that is inverse-transformed to a spatial domain is N×N, and the size of the original residual block is 2N×2N, the size of the residual block that is inverse-transformed to the spatial domain is enlarged to the size of the original residual block of 2N×2N through 1 wavelet inverse transformation. A level in which the wavelet inverse transformation is performed may be determined based on the size information of the original residual block.

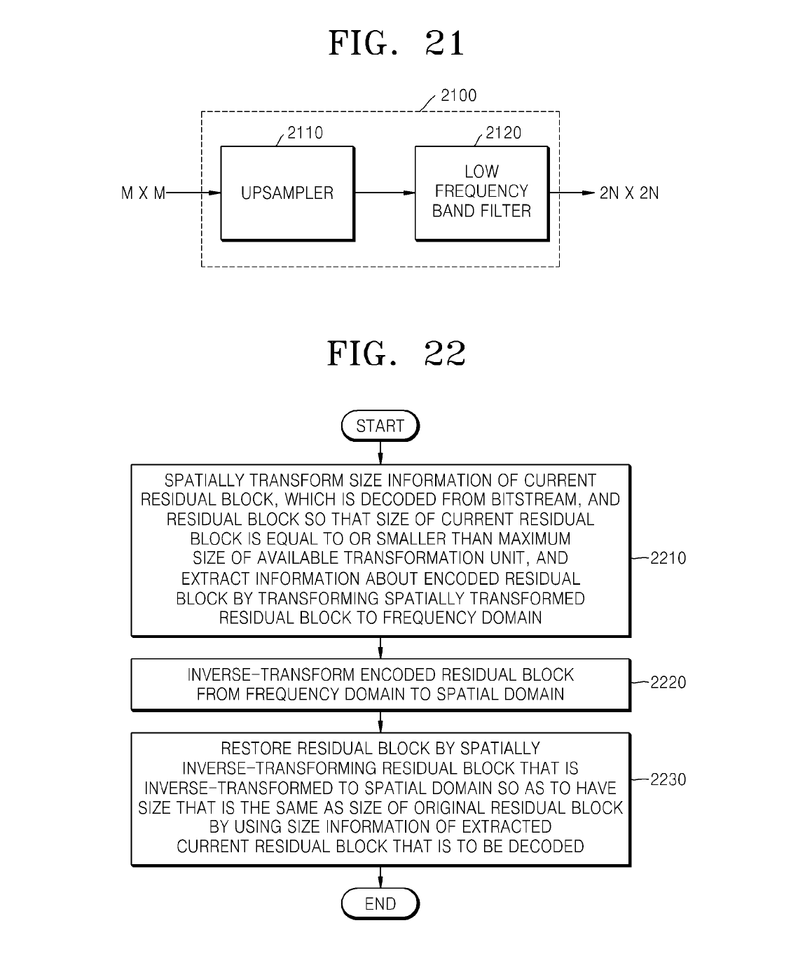

FIG. 21 is a block diagram of a spatial inverse-transformer 2100, according to an exemplary embodiment. The spatial inverse-transformer 2100 of FIG. 21 corresponds to the spatial inverse-transformer 540 of FIG. 5. Residual data that is transformed to a spatial domain is input to the spatial inverse-transformer 2100.

Referring to FIG. 21, the spatial inverse-transformer 2100 includes an upsampler 2110, and a low frequency band filter 2120.

The upsampler 2110 performs upsampling that is an inverse process of downsampling performed by the sub-sampler 1710 of FIG. 17. The upsampling may be repeated until the size of the residual block that is inverse-transformed to the spatial domain is the same as the size of the original residual block. The upsampling may be performed using various methods such as interpolating a ½ pixel or a ¼ pixel used in motion compensation. For example, pixels that are skipped during downsampling may be generated by using an average value of adjacent pixels so as to perform the interpolation. In FIG. 18, values of skipped pixels positioned between the sub-sampled adjacent pixels may be calculated by calculating an average value of sub-sampled adjacent pixels.

The low frequency band filter 2120 filters the upsampled residual block by using a low-pass filter.

FIG. 22 is a flowchart of an image decoding method according to an exemplary embodiment.

Referring to FIG. 22, in operation 2210, size information of a current residual block to be decoded and information about the encoded residual block, which is spatially transformed so that the size of the current residual block is equal to or smaller than the maximum size of an available transformation unit and transformed to a frequency domain, is extracted from a bitstream.

In operation 2220, the encoded residual block is inverse-transformed from a frequency domain to a spatial domain.

In operation 2230, the residual block that is inverse-transformed to the spatial domain is spatially inverse-transformed to have a size that is the same as the size of the original residual block by using the extracted size information of the current residual block that is to be decoded so as to restore the residual block. In this case, the residual block is spatially inverse-transformed so that the size of the residual block that is inverse-transformed to the spatial domain may be the same as the size of the original residual block by performing inverse wavelet transformation on the residual block that is inverse-transformed to the spatial domain, or by upsampling the residual block that is inverse-transformed to the spatial domain.

The exemplary embodiments may be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion. Alternatively, the exemplary embodiments may be embodied as a computer readable transmission medium, as signals or carrier waves, for transmission over a network, such as a local area network or the Internet.

As will be understood by the skilled artisan, the exemplary embodiments may be implemented as software or hardware components, such as a Field Programmable Gate Array (FPGA) or Application Specific Integrated Circuit (ASIC), which performs certain tasks. A unit or module may advantageously be configured to reside on the addressable storage medium and configured to execute on one or more processors or microprocessors. Thus, a unit or module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and units may be combined into fewer components and units or modules or further separated into additional components and units or modules.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of encoding a video, the method comprising:
generating a residual block comprising a difference between a prediction block of a current block and the current block;
determining whether a size of the residual block is larger than a maximum size of an available transformation unit;
spatially transforming the residual block to have a size that is equal to or smaller than the maximum size of the available transformation unit, in response to determining that the size of the residual block is larger than the maximum size of the available transformation unit; and
transforming the spatially transformed residual block to a frequency domain.

2. The method of claim 1, wherein the spatially transforming of the residual block comprises performing wavelet transformation on the residual block so that a size of a predetermined sub-band is equal to or smaller than the maximum size of the available transformation unit.

3. The method of claim 2, wherein the predetermined sub-band is a low frequency sub-band.

4. The method of claim 2, wherein the wavelet transformation is repeatedly performed until the size of the predetermined sub-band is equal to or smaller than the maximum size of the available transformation unit.

5. The method of claim 2, further comprising generating a sub-band that is scaled by multiplying the predetermined sub-band generated through the wavelet transformation by a predetermined weight.

6. The method of claim 5, wherein the weight comprises 2̂N, where N is a positive integer, when wavelet transformation is performed N times on the residual block.

7. The method of claim 1, wherein the spatially transforming of the residual block comprises transforming the residual block to have a size that is equal to or smaller than the maximum size of the available transformation unit by sub-sampling the residual block.

8. The method of claim 7, further comprising filtering the sub-sampled residual block by using a low-pass filter.

9. The method of claim 1, wherein the transforming of the spatially transformed residual block is performed using discrete cosine transform.

10. An apparatus for encoding a video, the apparatus comprising:
a spatial transformer that determines whether a size of a residual block, the residual block comprising a difference between a prediction block of a current block and the current block, is larger than a maximum size of an available transformation unit, and that spatially transforms the residual block to have a size that is equal to or smaller than the maximum size of the available transformation unit, in response to determining that the size of the residual block is larger than the maximum size of the available transformation unit; and
a frequency transformer that transforms the spatially transformed residual block to a frequency domain.

11. A method for decoding a video, the method comprising:
extracting size information of a current residual block to be decoded and information about an encoded current residual block that is spatially transformed so that a size of the current residual block is equal to or smaller than a maximum size of an available transformation unit and transformed to a frequency domain, from a bitstream;
inverse-transforming the encoded residual block from a frequency domain to a spatial domain; and
spatially inverse-transforming the inverse-transformed encoded residual block to have a size that is equal to a size of an original residual block using the extracted size information of the current residual block that is to be decoded to output a restored residual block.

12. The method of claim 11, wherein the inverse-transforming of the encoded residual block is performed using discrete cosine inverse-transform.

13. The method of claim 11, wherein the encoded residual block that is inverse-transformed to the spatial domain corresponds to a predetermined sub-band on which wavelet transformation is performed, and
wherein the spatially inverse-transforming comprises performing inverse wavelet transformation on the encoded residual block that is inverse-transformed to the spatial domain so that a size of the predetermined sub-band is equal to a size of the extracted current residual block.

14. The method of claim 13, wherein the predetermined sub-band is a low frequency sub-band.

15. The method of claim 11, further comprising generating a sub-band that is inverse-scaled by inverse-scaling of dividing the residual block that is inverse-transformed to a spatial domain corresponding to the predetermined sub-band, by a predetermined weight.

16. The method of claim 15, wherein the weight comprises 2̂N, where N is a positive integer, when wavelet transformation is performed N times on the residual block.

17. The method of claim 11, wherein the spatially inverse-transforming comprises spatially inverse-transforming the encoded residual block that is inverse-transformed to the spatial domain to have a size that is equal to a size of an original residual block by upsampling the inverse-transformed encoded residual block to output an upsampled residual block.

18. The method of claim 17, further comprising filtering the upsampled residual block by using a low-pass filter.

19. An apparatus for decoding a video, the apparatus comprising:
a parser that extracts size information of a current residual block to be decoded and information about an encoded current residual block that is spatially transformed so that a size of the current residual block is equal to or smaller than a maximum size of an available transformation unit and transformed to a frequency domain, from a bitstream;
a frequency inverse transformer that inverse-transforms the encoded residual block from a frequency domain to a spatial domain; and
a spatial inverse-transformer that restores the residual block by spatially inverse-transforming the inverse-transformed encoded residual block to have a size that is equal to a size of an original residual block using the extracted size information of the current residual block that is to be decoded.

20. A computer readable recording medium having recorded thereon a program for executing the method of claim 1.

21. A computer readable recording medium having recorded thereon a program for executing the method of any one of claim 11.
